(19) United States
(12) Patent Application Publication
(10) Pub. No.: US 2011/0073332 A1
(43) Pub. Date: Mar. 31, 2011

(54) SOIL CONDITIONING DISC AND CONFIGURABLE DISC ASSEMBLY

(76) Inventor: Keith Ward, Corydon, IN (US)

(21) Appl. No.: 12/892,603

(22) Filed: Sep. 28, 2010

Related U.S. Application Data
(60) Provisional application No. 61/246,324, filed on Sep. 28, 2009.

(51) Int. Cl. A01B 39/08; A01B 79/00; A01B 7/00

(52) U.S. Cl. 172/1; 172/537

(57) ABSTRACT

A soil-conditioning disc and variable disc assembly system is presented wherein each disc has a series of radially extending geometrically shaped protrusions with intermittent cutting edges and consolidation surfaces, all circumscribing a central hub portion. The disc can be used individually or in multiplicity in a variety of configurations as appropriate for the soil conditions and soil-conditioning task at hand. When the soil-conditioning disc is rolled across the soil surface, a series of consolidated perforations and/or geometric-shaped hollows and restricting channels (depending on the particular disc configuration utilized) are created in the soil. This soil-conditioning disc and assembly simultaneously cuts and incorporates organic material into the soil to increase soil oxygenation for improved soil health, to create depressional water storage, to enhance soil permeability, to reduce evaporation, and to improve surface water distribution by reducing runoff.

### CROSS-REFERENCE TO RELATED APPLICATIONS

This application claims priority to earlier-filed U.S. provisional patent application Ser. No. 61/246,324, filed Sep. 29, 2009.

### FIELD OF THE INVENTION

This invention relates to soil conditioning devices, and more particularly relates to a novel disc and a variable disc assembly and methods for tilling, cutting and laterally consolidating the soil while avoiding harmful compaction, thereby increasing infiltration, conserving moisture and reducing soil erosion.

### BACKGROUND OF THE INVENTION

Soil health has declined steadily for a number of years and, coupled with the high rates of soil erosion, its rate of degradation is increasing around the globe. For this trend to stop and our soils to recover, new equipment and new farming practices need to be developed and adopted that improve soil and water management. The earth is losing topsoil and water aquifer levels are falling at alarming rates. Governments around the world are imposing soil and water conservation standards within the agricultural industry.

We need to preserve water around the world just as much as the soils as massive volumes of water are being wasted. Water in the soil makes crops grow, keeps them healthy, stops desertification, and helps regulate our climate. Of the global water supply, approximately ninety seven percent (97%) consists of salt water, the remaining three percent (3%) is fresh water; however, two percent (2%) of this fresh water is frozen in ice caps, glaciers, etc., which leaves only one percent (1%) of all the available fresh water to supply industry, agriculture and human consumption. Human consumption accounts for roughly thirty percent (30%) of the remaining one percent (1%).

There have been many attempts to address this situation in recent years, but global soil conditions continue to decline. One recent attempt to provide soil and water conservation in farming has been the practice of “No-Till” farming. No-Till farming is where the soil is left undisturbed from harvesting to the next planting cycle. Planting is accomplished in a narrow seedbed or slot created by disc openers. Coulters, residue managers, seed farmers, and modified closing wheels are used on the planting equipment to provide adequate seed-to-soil contact. However, there are several disadvantages associated with No-Till. No-Till requires the use of herbicides to eliminate competition from weeds and progressively increasing amounts of fertilizer, which simply raises production costs and not to mention pollution; the heavy residue left on the soil surface hinders soil warming and drying, rendering planting more difficult and resulting in poor seed-to-soil contact, thus reducing seed germination; and the soil surface is also left with a very low permeability, resulting in rain water runoff and reduced infiltration to subsurface soils thereby reducing aquifer recharge. While No-Till was developed to minimize soil erosion, which it does effectively, the lack of water management allows excess surface water from rainfall to run-off and, in fact, is often directed away from the field into nearby waterways in an attempt to stop ponding/flooding.

In contrast to No-Till, tilling the soil with disc harrows, field cultivators, and other similar equipment leaves the soil in a highly erodible condition. Consequently, it is necessary to use some form of “press” or “roller” to help consolidate the soil in an attempt to reduce the risk of erosion. It should be noted, however, that although tilled soil is far more absorbent than “No-Till” soil, during precipitation, rain drops impact the soil surface and dislodge soil particles, which then form to quickly seal the soil surface thus (referred to as “capping”). This phenomenon allows huge quantities of soil to be washed away in the ensuing surface water run-off. Thus, neither system is very effective at “water management” and, in the case of tilled soil, some form of erosion control needs to be employed.

A typical conventional tillage approach to these problems is the use of a “Disc Harrow” machine which is a very widely used piece of farming equipment that has been around for many years. A Disc Harrow is a farm implement used to cultivate the soil where crops are to be planted. It is also used to chop up unwanted weeds or crop residue and to break down large clods of soil typically left by plows, etc., into a suitable condition prior to creating a seed bed for planting. A Disc Harrow typically consists of many iron or steel discs, which have a slight concavity to them arranged into two or four sections. The four-section unit, when viewed from above, would appear to form an “X” as the discs in this unit are offset so that they are not parallel with the overall direction of the implement. This allows the leading discs to cut into the soil profile and the second off-set set of discs to slice the ground that has been cut by the first set in order to optimize the result. The concavity of the discs, as well as their being offset causes them to loosen and pickup the soil they cut.

There are several problems however with offset disc harrows. First, such an implement requires high horsepower due to the way in which the machine functions. Second, the shearing/scraping action created by the disc implements as they are dragged sideways across the soil causes “smearing” to the ground under the discs work area. Such smearing can cause a pan/hard layer to form that, over time, creates a layer that is impervious to water and air. Third, the disc harrow leaves the soil in a “highly erodible” condition. Some form of press/cage roller is used after the disc harrow implement in an attempt to prevent excessive erosion. There are several other types of tillage equipment that also have “discs” as part of a “multi-tool” soil preparation system, such as “disc-rippers” and “field cultivators.” Globally, there are some highly erodible soils that are very fertile, extremely fragile and very difficult to manage due to their high organic content. The use of a Disc Harrow machine in such soils is ill-advised; however, farmers have had little choice in the past.

More recently farmers have implemented RTS (Reservoir Tillage System) devices to overcome the pitfalls of traditional tillage systems and provide good water management practices. The operation of conventional RTS machines is to apply pressure perpendicular to the soil upon which they operate, whereupon they scoop, scrape, punch or compress pools or reservoirs in the soil surface. In operation, “diking” machines scoop or drag the soil to form the required shape or dams. “Imprinting” machines, on the other hand, compact the soil into the shape afforded by their design. Imprinting machines generally provide smaller, well-formed pools, as opposed to a diking machine's larger, loosely formed pools.

Even though compaction is often considered a negative term when discussing soil preparation and preservation practices on the farm, the process of compaction itself is dynamic and has different degrees. “Compaction” in soil is the direct result of weight applied to the soil's surface. When weight is applied to the soil, the soil structure is compressed. The greater the weight or load is, the higher the compaction rate is. When the soil is compressed to such a level that it becomes impervious to water, the soil below this point is effectively sealed off from water and oxygen, obstructing the soils ability to produce good crops. Compaction occurs quite frequently on farmland because of the type of cultivation used—a good example of equipment causing compaction is the moldboard plow. Further compaction is caused by high traffic, tractors, carts, etc., on the soil surface—this type of compaction is commonly known as a “hard pan.” In an effort to overcome this problem, farmers will often use equipment commonly known as “rippers,” “subsoilers” or “pan busters” to penetrate below the hard soil pan and fracture it, thus allowing moisture to better infiltrate the soil and promote healthy root systems for the crops. Slight or moderate compaction is referred to as “consolidation” and will not typically affect yields. A preferred RTS machine uses soil consolidation principles to imprint the soil and create a geometrically ordered roughness (GOR) on the soil surface. This optimum force creates impressions in the soil that promote good infiltration, while consolidating the soil enough to hold it in place during a good rainfall event. Too large a force will squeeze the soil until it becomes compacted. Results from research have demonstrated that soil conditioned and consolidated to create GOR increases water intake, reduces runoff and erosion, increases moisture content and reduces evaporation, all of which in turn increases plant germination, growth and crop yield. Soil compaction causes the opposite (negative) results.

A preferred RTS machine, from a practical standpoint, is considered to generate no compaction, since the movement of soil and water and plant growth and yield, is not affected negatively. Nonetheless, soil management practices should be changed to minimize the development of further compaction. When the degree of compaction is severe, from a practical standpoint it is considered to be a compaction problem. An example of such a conventional RTS machine is U.S. Pat. No. 7,478,684.

In the case of “imprinting and impressing” or “punching and compacting,” the soil is compacted in the first instance, therefore reducing the amount of soil particles that can be dislodged by water impact; however, such systems also reduce the soil's infiltration capability. While the better of these systems attempts to leave the soil loose on the sides by compacting the soil in the bottom of the pool only. However, such a system suffers from the loose particles of soil and organic matter being washed into the bottom of the pool, thereby capping or sealing the soil surface. These soil particles then build up and seal the sides of the pool, further reducing the infiltration rate. Once the pools are sealed or capped, over-topping quickly occurs. By definition, when the pools or reservoirs created by conventional systems are full, they are already close to failing. As water or rain fall accumulates on the imprinted soil surface, the soil needs to be able to absorb the water as it lands. Therefore, any water that starts to build up in the pools or reservoirs is exceeding the infiltration rate of the soil, eventually ending in over-topping and the inevitable loss of top soil by erosion. In the event of a storm, a large volume of water is distributed over the soil surface in a relatively short period of time. Even on relatively flat ground, there are high areas and low areas. In addition, even after farmland has been prepared with some form of erosion control, surrounding land that may have been left fallow as part of a rotation, or a government incentive program, may not have had any form of erosion control. If this unprepared land is higher than the prepared land, it is likely that surface water run-off will occur, causing damage and erosion to the prepared farm land. This scenario is often the worst type of situation, so it is imperative that the best possible soil erosion control techniques are used to minimize the damage and soil loss.

“Diking” machines operate by using a digging action to work the soil into pools or reservoirs, and do not require as much weight in order to operate. On the other hand, “imprinting” type machines use “compaction” to enable them to work and, by definition, require weight to be applied perpendicular to the soil surface, causing the soil structure to be impressed in order to leave their impressions or imprints. The best known example of an imprinting machine is the “Dixon Wheel” (U.S. Pat. No. 4,195,695). This unit was manufactured to the required weight to overcome the soil's surface structure in order to make an impression. This conventional device represents a good example of the amount of weight per foot that is required to compact/press holes or imprints into the ground.

More recent imprinting-type machines commonly use some form of soil disturbance in an effort to increase their efficiency and reduce the weight required to make an impression in the soil surface, consequently reducing the weight of the equipment. However, although these later-designed machines are lighter in weight than the Dixon Wheel and other similar devices, they are all still relatively heavy, and in some instances have to operate as a stand alone piece of equipment.

Traditionally, RTS machines operate at a very slow pace due to the manner by which they operate. Digging type machines operate most efficiently at around 4 mph, but later designs can operate at 5 to 6 mph without throwing too much soil. As these machines leave the soil “loose” while forming their dams, soil being thrown while operating at these higher speeds is an acceptable occurrence. However, imprinting-type RTS machines, which impress or compact the soil surface into the required shape to form reservoirs, generally travel fast, i.e., 5 to 6 mph. The part of the wheel or roller that is impressed into the soil surface (referred to as the “former”) carries with it a considerable amount of soil as it leaves the soil surface. As this soil is thrown from the rear of the roller, it develops a characteristic “rooster tail” effect.

A preferred RTS system can operate at speeds over 10 mph (necessary on some high-speed cultivators). This feat is accomplished by the shape of the “former” and the manner in which it operates. As the former is rotating as it leaves the soil, it is pushing the soil sideways (referred to as “lateral consolidation”). This action, along with the design of the former, separates the former from the soil before it even leaves the soil surface to reduce the rooster tail effect.

All things considered, there remains a need for improving soil and water conservation in our current balance between economics and the environment to become sustainable.

### SUMMARY OF THE INVENTION

The present invention is comprised of a soil-conditioning disc and variable system wherein each disc has a series of radially extending geometrically shaped protrusions circumscribing a central hub portion. When the soil conditioning disc system is rolled across the soil surface, a series of consolidated perforations and/or geometric shaped hollows (depending on the particular disc configuration) are created in the soil. This soil conditioning incorporates organic material in the soil and increases soil oxygenation for improved (particularly clay soils) soil health, creates depressional water storage, enhances soil permeability, reduces evaporation, creates even surface water distribution and reduces water runoff. An important purpose of the soil-conditioning disc and system is to enable the soil to retain rain water where it falls, reduce erosion, increase water retention and infiltration of the soil and to improve soil quality.

The soil-conditioning disc system of this invention is a rotary device that can be attached to most any existing agricultural and horticultural machine, as well as to any specially designed machine for use in construction, mining or other situations that require earthworks, including home gardening. Additionally, the soil-conditioning disc system may be fitted to an animal or human powered device having this disc system serving as its wheels/depth control. Several soil-conditioning disc systems may be adjacently aligned to form a soil-conditioning tool having a plurality of such disc systems. Additionally, the disc system can be fitted with a break or clutch device, or can be driven mechanically from a variety of sources at speeds necessary for multitasking. Rolling of the soil-conditioning disc system across the soil surface may be accomplished with a mechanized, human, or animal powered apparatus. The disc system may also serve as the wheels for the apparatus rolling the assembly or passively pulled with the apparatus. Preferably, a transport means such as a tractor will pull an implement having a plurality of the discs of this invention mounted thereon.

The soil-conditioning disc and related system provided by this invention cuts, molds and consolidates the soil upon which it is rolled or driven by applying light pressure to the soil surface in a substantially horizontal direction so as to lightly consolidate or bind the outermost surface of the soil together. Consolidating the soil surface lightly causes the outermost surface soil particles to stick together, leaving a porous permeable soil surface for greater infiltration capabilities. The device rotates within the soil, forming and gently kneading the soil into place, producing a series of consolidated geometric hollows and leaving the soil surface with a Geometric Ordered Roughness (GOR), necessary for the control of erosion caused by water and wind and in a condition suitable for “rainwater harvesting.” This process of consolidating the soil requires no additional pressure or force perpendicular to the soil surface, thus providing no compaction to the soil structure. The consolidation is accomplished in a substantially lateral direction and shapes a structure in the soil consisting of various curves and angles, forming geometric perforations or hollows (depending on the disc configuration), which serves to increase the soil surface area. The increase in permeability and surface area of the soil both contribute to the increase in soil infiltration, soil moisture retention and consequent reduction in erosion.

Additionally, the geometric shape of the radial protrusions of each disc allows for the system to be operated at speeds necessary for efficient farm practices, particularly on high-speed field cultivators operating at 10 mph to 12 mph. The geometric hollows formed in the soil by this invention, when the discs are arranged in a “paired” manner, are designed to slow and/or stop flowing water, thereby allowing it to better infiltrate the soil. These hollows are formed and consolidated evenly over the entire surface of the soil, which serves to increase the surface area of the soil as well as its infiltration rate. Increased soil surface area also increases soil warming from the sun that improves seed germination. Below this molded and consolidated surface formed by the disc system of this invention, the soil structure remains loose, thus allowing water to better percolate throughout the soil. These geometric-shaped hollows increase porosity, infiltration rate, and the water-absorbing capability of the soil, directly reducing erosion of the soil. By substantially eliminating and/or slowing water runoff, the soil is also left in the perfect condition for “rainwater harvesting.” Surface ponding on fields is also reduced since rainfall or irrigation water is more easily absorbed by the soil.

The soil-conditioning disc and system of this invention have many applications and benefits. It is capable of working on most all soil types and agricultural applications, such as plowing, cultivating, tilling, seed bed preparation, planting, raised bed preparation for vegetable production, common construction and mining applications, such as scraping, building berms, reclaiming land, or even creating meridians between interstate highways.

The disc and related system of the invention presented herein are further intended to “cut” and “consolidate” the soil. As noted above, research has shown that pressure applied perpendicularly to the soil surface can cause harmful compaction, thereby stunting plant growth. Research has also shown that lateral consolidation does not compact the soil, but rather promotes helpful permeable soil conditions and, when used in conjunction with a planter or seed drill, creates good soil-to-seed contact for fast emergence and improved plant counts and crop yields. Such a cutting and pressing action also serves to cut and incorporate plant residue back into the soil, thereby introducing organic material into the soil, making it ideal for a fall soil preparation regimen.

The cutting/mixing and lateral consolidating process is followed by a perpendicular consolidating action to the soil surface which takes place as the disc system rolls across the surface. This action ensures that the chopped residue is in full contact with the soil to assist in its rapid breakdown into beneficial organic matter. The perpendicular consolidation is achieved by the flat areas at the base and between the radially extending geometric protrusions of each disc.

There are several alternative configurations for this novel disc assembly, i.e. “single,” “paired,” “opposed” and “angled.” Each configuration has a specific purpose, e.g. planting, residue management, perforating, cultivating/tillage and RTS/GOR applications. When the invention is being used in a planting system such as a strip-till planter in light soil conditions, the disc systems would be “paired” for use as an effective closing device with the additional benefit of adding an effective RTS/GOR system to the planter with no extra weight or components. Therefore, any rainfall or irrigation water that fell on the seed bed would be captured, thus enabling moisture to be concentrated in the root area of the plants/crops to produce healthier plants and root systems and subsequent higher yields.

The economic and environmental benefits generated by this novel disc assembly of this invention are many:
Increased crop yields
Reduced labor, chemical and water usage and costs
Ease of use
Works well in virtually all soil types, for a variety of crops and at relatively high speeds
Recharging of aquifers and reversed desertification via enhanced soil and water management
Reduced soil erosion, water and chemical run-off
Improved soil quality by increased residual soil moisture, increased organic material, increased oxygenation and enhanced stability

Various RTS and GOR devices have been tested and validated independently by the inventor. The efficiency, ease of use, user acceptance and longevity of these other conventional devices has proven to be poor. The present invention was designed to overcome the shortcomings of these conventional systems. The technology of this invention can assist farmers to be both sustainable and profitable, while controlling erosion during the process of feeding people globally in an environmentally friendly and green manner.

### BRIEF DESCRIPTION OF THE DRAWINGS

FIG. 1 is a perspective view of a prior art farm implement coupled to a conventional pulling device (tractor).

FIG. 2 shows a perspective view of the novel disc provided by this invention.

FIG. 3A shows a plan view of the novel disc provided by this invention, while FIG. 3B presents a cross-section profile taken along plane 3B of FIG. 3A.

FIG. 4 is a side plan view of a first embodiment the disc of FIG. 2 of this invention coupled to a farm implement.

FIG. 5 shows a side plan exploded view of a pair of discs provided by this invention arranged in a paired “facing” orientation coupled with a conventional driving mechanism (hub-and-axle means).

FIG. 6 is an isolated view of a pair of paired discs provided by this invention.

FIG. 7 presents a cross-section of the paired disc assembly of FIG. 5.

FIG. 8 is a top view of the soil having been conditioned by a paired disc assembly provided by one embodiment of this invention.

FIG. 9 is a plan view of yet another alternate embodiment of the variable disc system provided by this invention wherein the discs are arranged in a facing orientation but spaced further apart than the embodiment of FIGS. 6-8.

FIG. 10 is a view of an alternate embodiment of the variable disc system provided by this invention where the discs are arranged in an outwardly facing or opposed orientation, accompanied by a top view of the soil having been conditioned by this alternative disc assembly.

FIG. 11 presents a side view of the disc assembly of yet another embodiment of this invention, wherein paired disc assemblies 22a and 22b are disposed in an “angled” orientation.

FIG. 12 presents a rear plan view showing how the discs of the assembly of FIG. 11 operate and interact within the soil profile.

FIG. 13 presents a top view of the paired disc assemblies 22a and 22b shown in FIG. 11.

FIG. 14 presents a front plan isolated view of a paired disc assembly of the invention typically used for sandy and highly erodible soils.

FIG. 15 presents a front plan isolated view of a paired disc assembly of the invention typically used for high-residue conditions and for medium-to-heavy soil types.

### DETAILED DESCRIPTION OF THE INVENTION

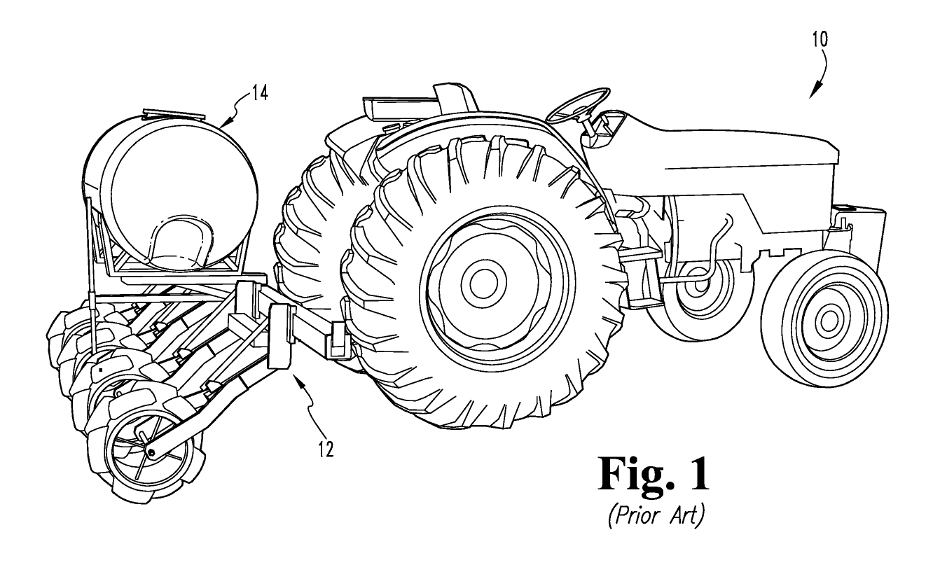

FIG. 1 shows a conventional arrangement of a piece of farm machinery (tractor) 10 pulling a farm implement 12 for treating or managing the crop field soil. Applicant's soil-conditioning disc and variable disc assemblies are preferably similarly intended to be carried by a farm implement 12 and can either be pulled or pushed over the soil. Farm implement 12 can further be equipped with a seed hopper or fertilizer tank 14 well known in the art.

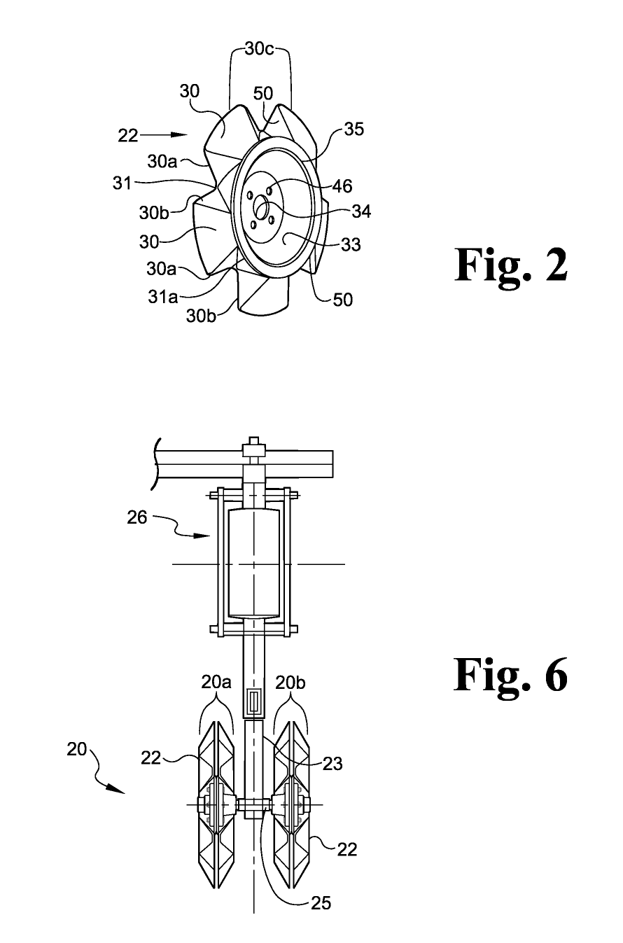

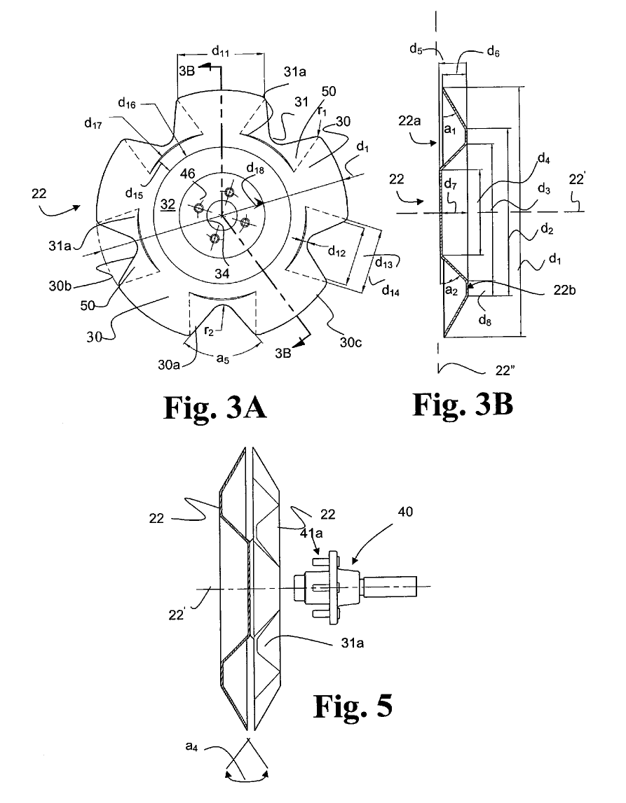

FIGS. 2, 3A and 3B show a preferred embodiment of the disc 22 provided by this invention comprising a generally star-shaped member having multiple (preferably at least two) peripheral extensions or protrusions 30 that extend radially outwardly from a central hub portion 32 having a central opening 34. As shown in FIG. 3B, disc 22 has a first side 22a, a second opposing side 22b, a central axis 22′ and a longitudinal axis 22″. The disc of this invention can have more or less peripheral extensions depending on a greater or smaller diameter. In a preferred embodiment, there are five radial protrusions 30 (hence, “star-shaped”) arranged circumferentially about hub 32. Each protrusion 30 is preferably geometrically shaped and spaced equally and intermittently circumscribing hub 32 with inner cutting edges 31 spaced therebetween. Protrusions 30 can be manufactured in various sizes to suit various crops and soil types, either larger or smaller.

Each disc 22 is equipped with a consolidation area 31a, shown best in FIGS. 2 and 3A, that is preferably substantially parallel to the central axis 22′ of disc 22. Each protruding portion 30 also has a first or leading edge 30a, a second or trailing edge 30b and an intermediate outer annular edge 30c spanning between the first and second edges. (Obviously, the designation of either edge being the “leading” edge depends on the direction in which disc 22 is traveling.) While edges 30a and 30b are preferably linear or straight and slope toward hub 32, curved edges may also prove suitable. The first edge 30a of each protrusion 30 meets the second edge 30b of each adjacent protrusion to define the intermittent inner cutting edges 31.

Each disc 22 is preferably constructed from pressed or forged steel; it could also be constructed from cast iron, while other suitable hard materials will suffice. Plastic could also be used for light weight horticultural and home garden applications. Generally, however, it is preferred that the disc be of sufficient weight in order to roll flat and consolidate the soil by way of the consolidation areas 31a of disc 22 and form the hollow or perforations in the soil.

As may be readily seen in the drawings, disc 22 is by no means flat or planar. Rather, disc 22 has a three-dimensional shape whereby the annular edge 30c lies on a first plane generally common with hub 32, whereas an inner annular portion 33 extends away from the first plane to adjoin a rim 35 that lies on a second place parallel to but spaced apart from the first plane. From rim 35, consolidation areas 31a extend perpendicular therefrom toward the first place in generally a triangular shape, while protrusion 30 slopes away from the hub 32 toward the first place terminating in annular edge 30c, which lies in the first plane. Intermediate transition surfaces 50 lie interposed consolidation areas 31a and protrusions 30. The outer perimeters of transition surface 50 is defined by first or second edges 30a, 30b, and its boundary of abutment with protrusion 30 and consolidation area 31a. The diameter of the circle formed by outer edges 30c is greater than the diameter of rim 35.

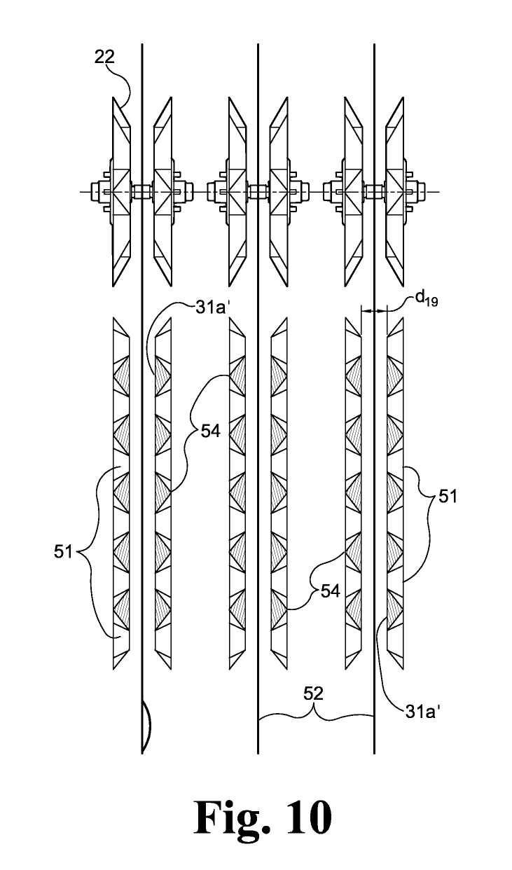

As explained further below, when disc 22 is rolled over the soil, it is first edge 30a and adjacent surface transition 50 that first engage the soil, followed by outer edge 30c that then forms the bottom of the depression or hollows 50. Next, second edge 30b and its corresponding adjacent surface 50 then exit the soil leaving a geometric depression in the soil, followed by consolidation area 30a that forms the wells or dams in the soil as shown in FIGS. 8 and 10.

Referring now to FIGS. 2, 3A and 8, the consolidation of the soil and formation of the soil dams is achieved by the annular areas 31a of each disc 22 disposed at the base of the hub between the radially extending protrusions 30. This action ensures that the chopped residue is pressed in full contact with the soil to assist in its rapid breakdown into beneficial organic matter. This intermittent consolidation area 31a of each disc 22 is equally spaced around the circumference of the flat area of the disc 22 disposed between the protrusions 30. Each such consolidation area is essentially equilateral-triangular in shape, is preferably approximately 153 mm long and 50 mm wide with a working area of 4262 sq mm. As best seen in FIG. 8, the hatched areas 31a of the soil depict the generally flat consolidation areas on the soil, while the shaded areas on the disc assembly show the corresponding consolidation areas 31a of each disc 22.

While this invention is not of a specific size or weight, in a most preferred embodiment the dimensions of disc 22 are as follows:

### Preferred Disc Dimensions

### Distances

d₁=525.00 mm
d₂=351.34 mm
d₃=287.37 mm
d₄=179.16 mm
d₅=57.59 mm
d₆=50.09 mm
d₇=53.59 mm
d₈=31.98 mm
d₉=115.18 mm
d₁₀=15.00 mm (minimum)
d₁₁=181.51 mm
d₁₂=10.00 mm
d₁₃=125.33 mm
d₁₄=137.98 mm
d₁₅=31.31 mm
d₁₆=287.37 mm
d₁₇=350.00 mm
d₁₈=179.18 mm
d₁₉=Variable

### Angles and Radiuses

a₁=30°
a₂=45°
a₃=76°
a₄=60°
a₅=82°
a₆=20°
a₇=0°
a₈>90°
r₁=15 mm
r₂=25.87 mm

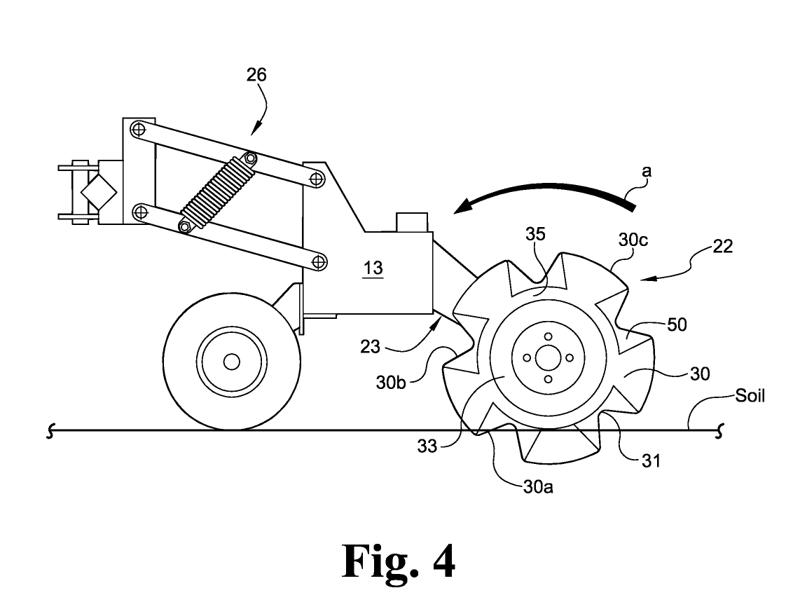

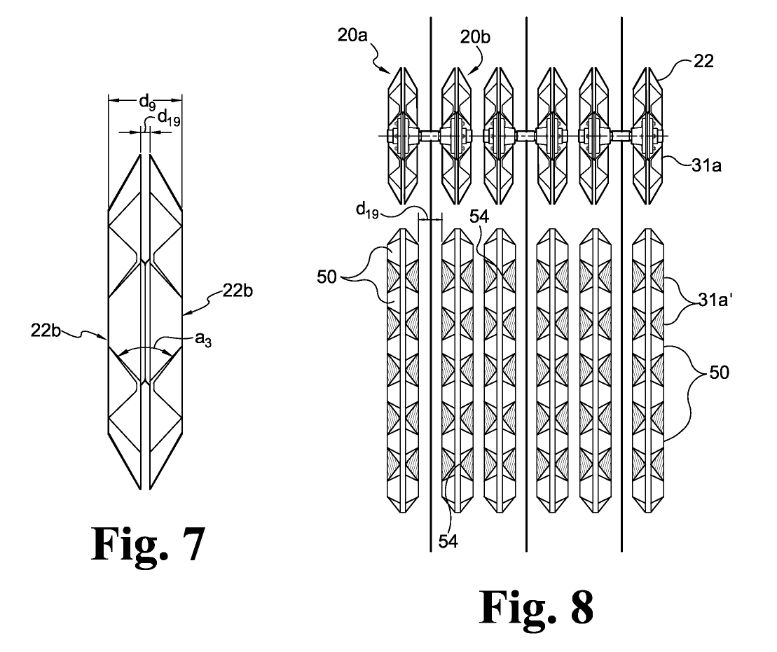

In one preferred disc system or assembly shown in FIGS. 4-8, intended for use with any planting system, individual discs 22 are arranged in a “paired” fashion for use as an effective RTS/GOR device, while also cutting and incorporating plant residue into the seed bed area to insure its rapid breakdown into organic matter. Such an arrangement also consolidates the seed bed area, ensuring excellent soil-to-seed contact, and is particularly effective for light to medium soil types and high-residue conditions. In such an arrangement, multiple discs 22 are disposed in paired assemblies 20a, 20b, whereby their surfaces or sides 22b (see FIG. 3B) oppose each other and their surfaces or sides 22a are adjacent each other. Each disc assembly can be affixed to the farm implement 12 via a conventional yoke attachment 23 pivotally attached to an attachment means 13 of the farm implement as shown best in FIGS. 4 and 6. As with most conventional farm implements of this type, the paired discs 20a are further coupled to the farm implement 12 via shock absorbing means 26. As seen more particularly in FIG. 6, a first disc pair 20a and a second disc pair 20b are defined by the paired discs 22 mounted on the yoke assembly 23, coupled with an axle-and-hub means 25 that extends through the central opening 34 of each disc 22 and through a corresponding opening provided in yoke 23. The disc provided by the invention can be attached to a farm implement through a variety of ways well known in the field.

Within each disc pair 20a and 20b, the paired discs 22 are preferably mounted so that their respective protruding portions 30 align with each other. (It is within the scope of this invention, however, to mount the discs so that the protrusions of one disc pair are staggered with respect to an adjacent disc pair.) A spacer is optionally provided between the respective inner discs 22 of first and second disc pair 20a and 20b to rotate freely about the axle. If the disc assembly is mounted or assembled on a single axle holding or carrying many pairs of discs, they can be staggered as noted above. All of the discs are preferably locked on a single axle, which would be one of the preferred options, for example, for a Press Roller farm implement. When the disc assemblies are arranged with their protrusions 30 in an alternating or staggered arrangement, the user enjoys the benefit of a reduction in any synchronized “bounce” of the farm implement. Such a configuration also reduces the lateral consolidation pressure and is preferred for use in fragile soils.

The protrusions 30 of each disc 22 are designed so as not to scuff or scrape the soil as it leaves an impressed hollow or perforation in the soil, thereby leaving the soil in a more stable condition. The outer peripheral edge 30c of each protrusion 30 is arcuate or slightly curved and preferably lies on the outer circumference of a circle, the center of which coincides with the center axis 22′ of disc 22. The opposing walls of protrusions 30 of each disc 22 have a combined angle a₄ (see FIG. 5) preferably in the range of approximately 45 degrees to 90 degrees, and most preferably about 60 degrees.

Rolling or driving the disc assembly 20 shown in FIGS. 6 and 8 upon the soil surface creates a permeable soil surface by generating a series of geometrically shaped hollows or perforations 50 (depending on the configuration—paired or single, respectively) that serves to increase the soil's surface area to improve infiltration and control surface water flow across the soil surface, thereby decreasing surface water runoff. By such action the soil surface is also consolidated, thereby improving resistance to movement of soil particles by moving water, while increasing permeability as the infiltration capability of the soil is increased. The series of geometric hollows created by the paired discs of this invention slow and direct the flow of water across the soil surface, resulting in a cascading effect, where each hollow or pool is filled sequentially as the water runs along the series of hollows. (Such a cascading effect only applies when the soil field is not level. If the field is level, the hollows or perforations act to catch or pool the rainwater.) This cascading effect in sloped fields reduces the inertia and momentum of the flowing water from higher ground to lower ground, which further serves to minimize the erosion of the surrounding soil.

The disc and related assemblies provided by this invention are capable of being coupled to the farm implement in a variety of ways such that the orientation and number of discs 22 can be varied according to the user's specific needs. For example, when a plurality of paired or opposed discs 22 are utilized, a number of rows or columns of impressions are created over a predetermined parcel of land as shown in FIGS. 8 and 10, respectively. To ensure that the hollows or perforations created by the disc are symmetrical, the shape of the circumscribing protrusions 30 of each disc 22 are preferably identical, as well as the circumferential spacing between adjacent protrusions 30. The nature of the soil hollows or perforations created by the variable arrangement provided by this invention is determined by the number of discs provided, secondly, the spacing between the discs and, finally, the relative position of adjacent protrusions on adjacent discs mounted on the assembly.

Referring now specifically to FIG. 8, it can be seen that three (3) assemblies of discs 22 arranged in a “paired” fashion produce a soil impression comprising a corresponding number of rows of hollows. Such a disc arrangement, while in contact with the soil, consolidates the soil in a series of geometric-shaped hollows 50 and adjoining restricting channels 54. The geometric-shaped hollow 50 includes a leading end, a mid-section, and a trailing end, which are correspondingly formed by the leading edge 30a, circumferential outer edge 30c, and trailing edge 30b, of each protrusion 30 of disc 22. Having leading edge 30a first contacting the soil allows the soil to be slightly laterally consolidated per the sloped configuration of protrusion 30, while the trailing edge 30b also in the same shape allows the disc to move through the soil at an increased speed as the disc rotates in the direction of reference arrow “a” (FIG. 4) as it is pulled or pushed along over the soil without throwing or pitching the soil, and avoiding the aforementioned “rooster tail” effect.

As shown in FIG. 10, however, when the discs 22 are arranged singly in an opposing manner with surfaces 22b (see FIG. 3B) facing each other, such an arrangement produces a different soil impression pattern comprising a corresponding number of rows of similarly opposing perforations 51. The hollows and perforations are shown in FIGS. 8 and 10 respectively, in an aligned arrangement; however, such impressions can be provided in a staggered arrangement by simply mounting the discs 22 on the axle means such that the protrusions 30 of one disc or paired disc assembly are staggered from the corresponding protrusions of the adjacent disc or assemblies. Such variations fall within the scope of the present invention.

In a preferred arrangement, while the disc system provided by this invention is mounted rearward of the farm implement to which it is coupled, the system can also be mounted forward of the implement, whether that implement be a seed drill/planter, fertilizer or the like, as shown in FIG. 1, and even self-propelled. This invention can also be powered manually or by animal. Accordingly, this invention is capable of treating soil that is to be sown with seeds or soil already sown with seed, to create the string or series of geometric impressed hollows that uniformly retain rainfall and safeguard against detrimental soil erosion.

In the assembly of the variable disc assemblies provided by this invention, attaching hubs 40 as best shown in FIGS. 5, 6, 8 and 10, extend axially from the disc and is coupled thereto by conventional lug-and-bolt means 41a that extend through corresponding openings 46 provided in the hub portion 32 of each disc (see FIGS. 2 and 3A).

While one preferred embodiment of this invention as shown in FIGS. 5-8 includes a pair of paired disc assemblies 20a and 20b, a significant advantage of this invention is that the discs can be arranged in a variety of configurations and the spacing between adjacent disc or disc assemblies can be varied depending upon the size of the planted crop. For example, in lighter soil conditions, the disc configuration as shown in FIG. 10 is preferred, whereby the discs 22 are arranged in an “opposing” fashion with no pairing taking place. As noted above, FIG. 10 also shows a top perspective view of the patter of soil perforations 51 formed by the assembly shown in FIG. 10 where discs 22 are arranged in an opposing relation to each other. The series of perforations 51 are arranged linearly on opposing sides of the seed line 52 along which the germinated crop grows. (On a related note as shown in FIG. 6, the lateral space between the inner discs 22 of first pair 20a and second pair 20b is preferably the location of the seed line.) The lateral distance d₁₉ between adjacent hollows 50 or perforations 51 in FIGS. 8 and 10, respectively, can be varied to suit crops and varying conditions, but is preferably about 85 mm.

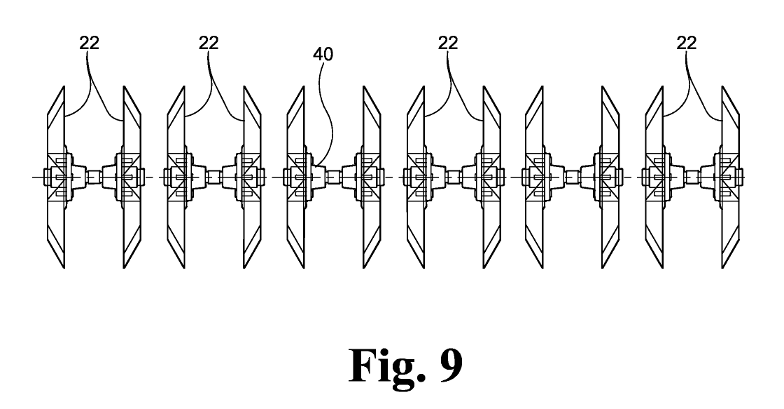

Referring now to FIG. 9, yet another preferred arrangement shows disc 22 in a paired “facing” relationship, yet at a greater lateral distance than the paired configuration shown in FIGS. 5, 6 and 8. This particular configuration is preferred for medium-to-heavy soils for use during the fall cultivation during the first harvest, wherein discs 22 cut plant residue and incorporate the residue back into the soil to increase its stability and reduce erosion.

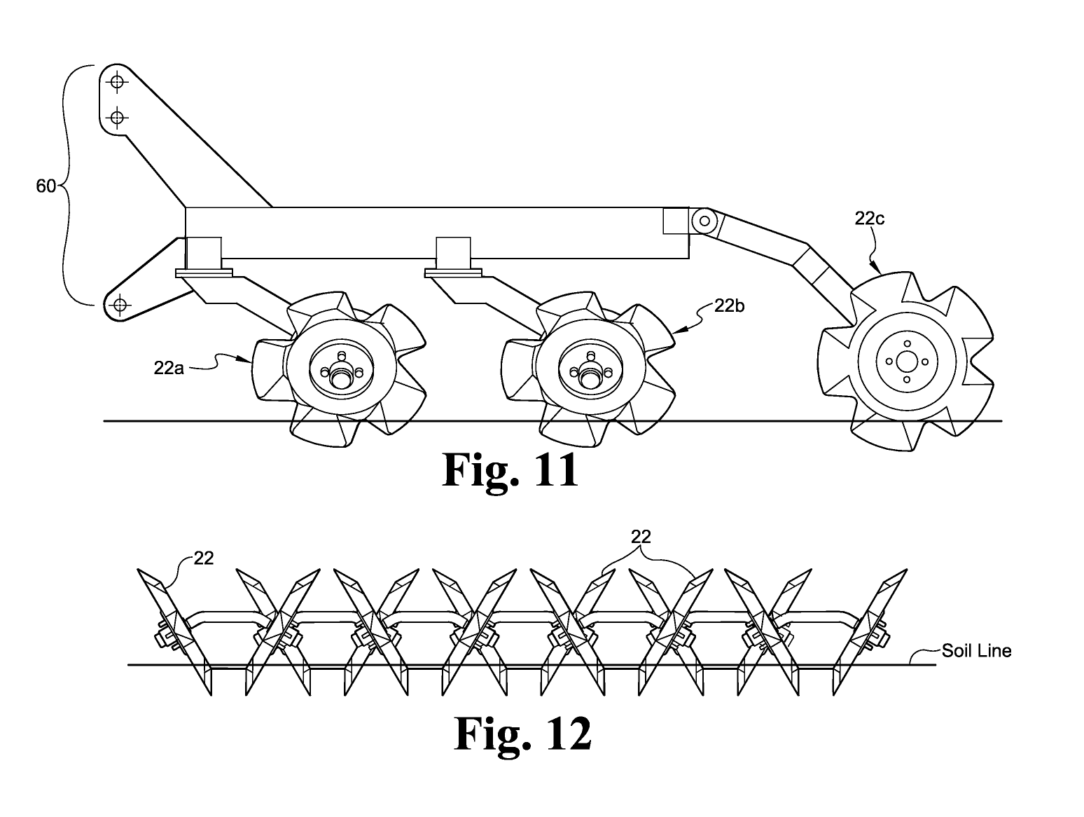

Yet another alternative disc arrangement is shown in FIG. 11, wherein trailing disc means 22c is positioned vertically and leading and intermediate disc means 22a and 22b are positioned at an “angled” orientation in relation to vertical. This angled configuration increases the assembly's ability to perforate hard, dry soils, and is particularly useful in cutting and incorporating residue back into the soil to provide excellent mixing of the soil. Trailing disc means 22c then consolidates the soil surface and, in the configuration shown in FIG. 11, offers increased soil stability by introducing a RTS/GOR practice. This configuration is preferably attached to the tractor by conventional means such as a 3-point linkage 60.

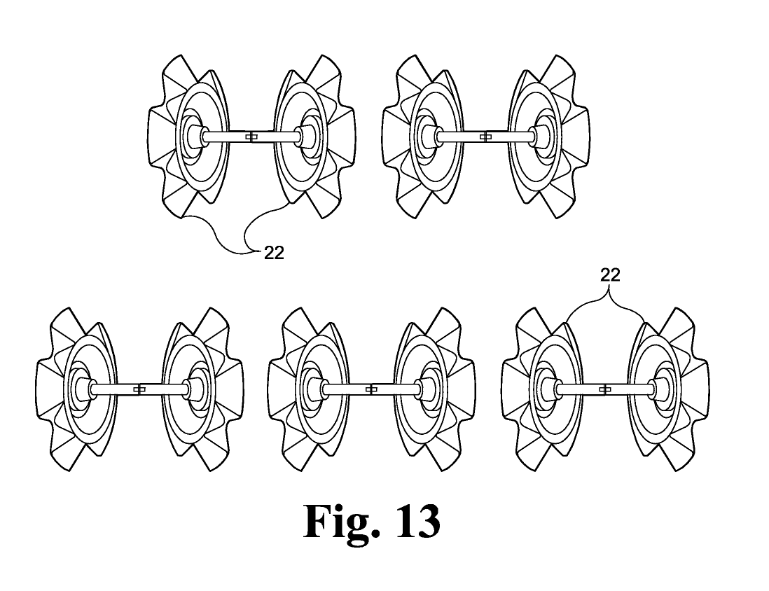

FIG. 12, which presents a view from the rear of the assembly of FIG. 11 looking through the disc means 22a and 22b, shows the interaction of disc means 22a and 22b within the soil profile. This is a preferred arrangement for cultivation and residue management. FIG. 13 shows an isolated view (top) of the disc means 22a and 22b in FIG. 11.

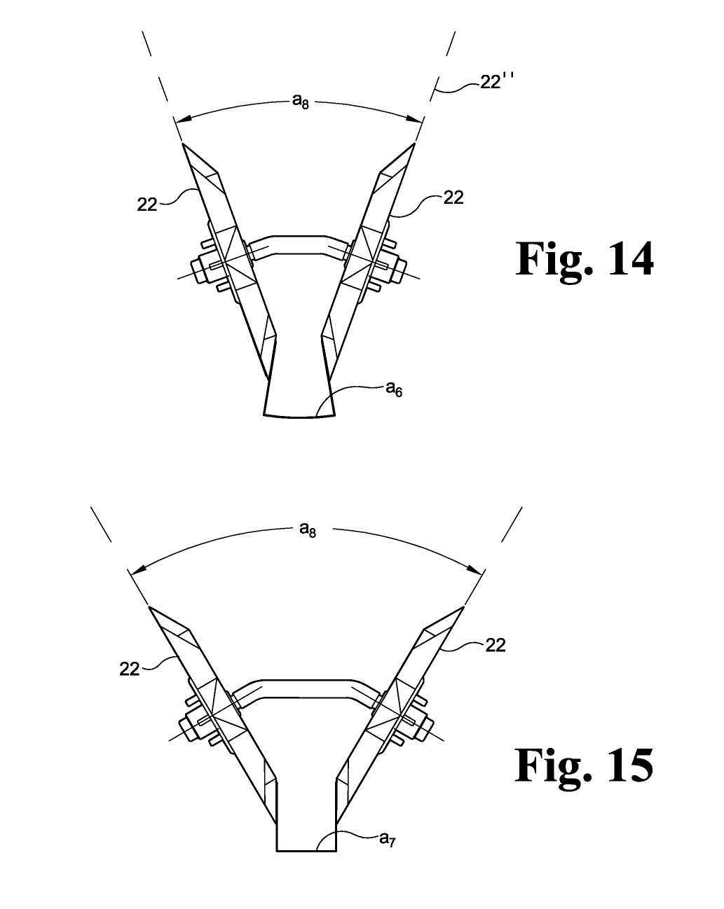

In the event sandy and highly erodible soils are encountered, yet another alternative disc arrangement shown in FIG. 14 is preferred, wherein discs 22 are arranged in a shallow “V” configuration. The angle a₆ between the edges of discs 22 in this embodiment is preferably about 20° degrees. FIG. 15 depicts a similar yet further alternative arrangement wherein discs 22 are also arranged in a “V” configuration for an increased cutting action as in the arrangement of FIG. 11 with the included angle a₇ of the edges being about 0° degrees as the edges of discs 22 are set generally parallel. This configuration is a particularly useful arrangement for high-residue/trash conditions. As shown in FIGS. 14 and 15, the angle a₈ between the longitudinal axes of discs 22 is obtuse.

This invention also provides a novel method of conditioning soil. Such a method includes generally the steps of providing the novel disc 22 of this invention as described above and creating a series of hollows 50 or perforations 51 and restricting channels 54 (see FIGS. 8 and 10) in the soil by rolling the disc over the soil. The series of consolidated perforations and/or geometric-shaped hollows in the soil is formed by first engaging the soil surface with the first or leading edge 30a of the protrusion 30 of the disc, moving the soil laterally as the protrusion 30 further engages the soil surface as the disc 22 is continuously rolled thereover, and forming a resulting cavity 50 and restricting channel 54 in the soil for controlling water by the second or trailing edge of said protrusion leaving the soil. The three-dimensional shape of disc 22 allows the protrusion 30 to move the soil laterally as the disc rolls over and engages the soil. The resulting soil cavity has a bottom formed by the intermediate outer annular edge surface 30c of the protrusion 30.

Such method can further comprising the steps of providing at least one or more novel discs of this invention as described above and arranging the discs such that their longitudinal axes are substantially parallel, as shown in FIG. 6 or FIG. 10 for example. In addition, the discs can be arranged such that the side 22a of one disc is disposed adjacent side 22a of the adjacent disc in a paired manner, as shown for example in FIGS. 6 and 9. Alternatively, the discs can be arranged such that the side 22b of the first disc is disposed adjacent side 22b of the second disc of said pair of discs in an opposing manner, as shown for example in FIG. 10.

As shown in FIGS. 11 and 12, the method of this invention can also included arranging disc 22 such that its longitudinal axis is not vertical. When adding one or more discs to the assembly, the discs can be further arranged such that the longitudinal axes of the discs are not parallel. FIGS. 11-15 show such an exemplary arrangement.

While the invention has been described in conjunction with preferred and specific embodiments thereof, it will be understood that this description is intended to illustrate and not limit the scope of the invention which is defined only by the claims herein.

1. A disc for conditioning soil comprising:
a central hub lying on a first plane and having a central opening and a central axis;
two or more protrusions extending radially outwardly from said central hub, each said protrusion having a geometric shape and being spaced equally and intermittently circumscribing the central hub;
inner cutting edges spaced intermittently between said protrusions circumscribing the central hub; and
consolidation surfaces spaced intermittently between said protrusions circumscribing the central hub;
wherein each said protrusion has a first leading edge, a second trailing edge and an intermediate outer annular edge spanning between said first and second edges.

2. The soil-conditioning disc of claim 1 wherein the first and second edges of said protrusion are linear and slope toward said central hub and adjoin said inner cutting edges.

3. The soil-conditioning disc of claim 1 wherein the first edge of said protrusion meets the second edge of an adjacent protrusion to define and give said inner cutting edge a concave shape.

4. The soil-conditioning disc of claim 1 wherein said consolidation surfaces are disposed adjacent such inner cutting edges and substantially parallel to the central axis of said disc.

5. The soil-conditioning disc of claim 1 wherein said consolidation surfaces are generally triangular in shape.

6. The soil-conditioning disc of claim 1 wherein the disc has a three-dimensional shape and the outer annular edge of said protrusion lies in a plane common with the central hub of said disc.

7. The soil-conditioning disc of claim 1 further comprising:
an annular rim, said rim lying in a second plane spaced apart from but parallel to said first plane; and
an annular portion extending between said central hub and said rim;
wherein said protrusion slopes radially away from said rim toward the first plane such that the outer annular edge of said protrusion lies in the first plane common with the central hub of said disc.

8. The soil-conditioning disc as in claim 1 where said disc is constructed from steel.

9. The soil-conditioning disc as in claim 1 where said disc is constructed from iron.

10. The soil-conditioning disc as in claim 1 where said disc is constructed from plastic.

11. A disc assembly for conditioning soil, comprising:
a pair of discs, each disc having a first side, a second opposing side, a central axis, a longitudinal axis, a central hub having a central opening, two or more protrusions extending radially outwardly from said central hub, each said protrusion having a geometric shape and being spaced equally and intermittently circumscribing the central hub, inner cutting edges spaced intermittently between said protrusions circumscribing the central hub, and consolidation surfaces spaced intermittently between said protrusions circumscribing the central hub.

12. The soil-conditioning disc assembly of claim 11 wherein the first of said pair of discs is arranged in a configuration with the first side of said first disc adjacent the first side of the second disc of said pair of discs in a paired manner, and
the longitudinal axis of the first of said pair of discs is substantially parallel to the longitudinal axis of the second of said pair of discs.

13. The soil-conditioning disc assembly of claim 11 wherein the first of said pair of discs is arranged in a configuration with the second side of said first disc adjacent the second side of said second disc of said pair of discs in an opposing manner, and
the longitudinal axis of the first of said pair of discs is substantially parallel to the longitudinal axis of the second of said pair of discs.

14. The soil-conditioning disc assembly of claim 11 wherein the first of said pair of discs is arranged in a configuration wherein the longitudinal axis of the first of said pair of discs is disposed at an obtuse angle relative to the longitudinal axis of the second of said pair of discs.

15. The soil-conditioning disc assembly of claim 11 wherein said discs are mounted on a farm implement on opposite ends of axle means for moving over soil, and
said discs are mounted such that the spacing between said discs can be varied by the user.

16. An apparatus used to condition and cultivate soil, said apparatus comprising:
means for moving the apparatus over the soil;
at least one disc transported by said apparatus, said disc comprising a first side, a second opposing side, a central axis, a longitudinal axis, a central hub having a central opening, two or more protrusions extending radially outwardly from said central hub, each said protrusion have a geometric shape and being spaced equally and intermittently circumscribing the central hub, inner cutting edge portions spaced intermittently between said protrusions circumscribing the central hub, and consolidation surface portions spaced intermittently between said protrusions circumscribing the central hub;
said disc impacting the soil when rolled thereover and generating in the soil a series of consolidated perforations and/or geometric-shaped hollows corresponding to the size and shape of the disc for holding water and enhancing soil permeability.

17. The apparatus as in claim 16 having a plurality of said discs in axial alignment.

18. A method of conditioning soil, comprising:
providing at least one disc having a first side, a second opposing side, a longitudinal axis, a central hub having a central opening and a central axis, two or more protrusions extending radially outwardly from said central hub, each said protrusion having a geometric shape and being spaced equally and intermittently circumscribing the central hub, inner cutting edges spaced intermittently between said protrusions circumscribing the central hub, and consolidation surfaces spaced intermittently between said protrusions circumscribing the central hub, each said protrusion having a first edge, a second edge and an intermediate outer annular edge spanning between said first and second edges; and
creating in the soil a series of perforations with a restricting channel adjoining said hollows by rolling at least one disc over the soil.

19. The method of conditioning soil as in claim 18 wherein the step of creating a series of perforations in the soil is performed by the steps of:
first engaging the soil surface with the first or leading edge of the protrusion of said disc;
moving the soil laterally as the protrusion of said disc increasingly engages the soil surface as the disc is continuously rolled thereover; and
forming said perforation in the soil for controlling water by the second or trailing edge of said protrusion leaving the soil.

20. The method of conditioning soil as in claim 18 wherein the resulting soil perforation has a bottom formed by the outer annular edge of the protrusion spanning between the first and second edges of the protrusion of said disc.

21. The method of conditioning soil as in claim 18 further comprising the steps of:
providing at least two or more said discs; and
arranging a pair of discs such that the longitudinal axis of the first of said at least two or more discs is substantially parallel to the longitudinal axis of the second of said at least two or more discs.

22. The method of conditioning soil as in claim 21 further comprising the step of arranging said pair of discs such that the first side of said first disc is disposed adjacent the first side of the second disc in a paired manner, wherein the perforation is defined by a geometric-shaped hollow.

23. The method of conditioning soil as in claim 21 further comprising the step of arranging said pair of discs such that the second side of said first disc is disposed adjacent the second side of the second disc in an opposing manner.

24. The method of conditioning soil as in claim 18 further comprising the step of arranging said disc such that its longitudinal axis is not vertical.

25. The method of conditioning soil as in claim 18 further comprising the steps of:
providing at least two or more said discs; and
arranging one of said at least two or more discs such that the longitudinal axis of the first of said two or more discs is not parallel to the longitudinal axis of the second of said two or more discs.
